(19) United States
(12) Patent Application Publication
(10) Pub. No.: US 2009/0326424 A1
(43) Pub. Date: Dec. 31, 2009

(54) SINGING BOWL SOUND AND VIBRATION HEALING TABLE

(76) Inventor: Surendra Shrestha, Boulder, CO (US)

Correspondence Address: MARSH, FISCHMANN & BREYFOGLE LLP, 8055 East Tufts Avenue, Suite 450, Denver, CO, 80237, US

(21) Appl. No.: 12/488,203

(22) Filed: Jun. 19, 2009

Related U.S. Application Data
(60) Provisional application No. 61/076,125, filed on Jun. 26, 2008.

(51) Int. Cl. A61H 1/00

(52) U.S. Cl. 601/47

(57) ABSTRACT

Systems and methods (“utility”) for providing sound healing to person are provided herein. The utility may include a table sized to support a person undergoing the sound healing session. The utility may also include a plurality of auxiliary support structures or platforms sized to support one or more sound generating devices (such as singing bowls or speakers). The auxiliary platforms may be adjustable in one or more directions, and may be selectively removable from the table. The utility may also include an electronic device operative to drive the sound generating devices to implement a sound healing session. Further, the utility may include a mat that includes a plurality of sound generating devices located in positions designed to coincide with chakras of a person lying on the mat. In addition other support structures (e.g., a chair) may be provided to facilitate sound healing sessions.

### CROSS-REFERENCE TO RELATED APPLICATION

This application claims priority under 35 U.S.C. 119 to U.S. Provisional Application No. 61/076,125, entitled: “SINGING BOWL SOUND AND VIBRATION HEALING TABLE,” filed on Jun. 26, 2008, the contents of which are incorporated herein as if set forth in full.

### BACKGROUND

Sound healing, sometimes referred to as music therapy, is a method of promoting wellness used by many holistic health practitioners. The practice of using sound and music as a healing tool actually spans many ancient civilizations. For examples, Tibetan Buddhists have used singing bowls for centuries to fine-tune the body's energy fields, or chakras. Sound healing is a process that uses vibrational sound to help reduce stress, alter consciousness and create a sense of peace, well being and better health for a person. A sound healing session may typically involve generating a plurality of sounds in one or more sequences near the body of a person undergoing the sound healing session. Different tones and sequences may be used for various applications.

Generally, to produce tones, sound (or vibrational) healing utilizes singing bowls, also known as “Himalayan bowls,” which are a type of bell, specifically classified as a standing bell. Rather than hanging inverted or attached to a handle, standing bells sit with the bottom surface resting. The sides and rim of singing bowls vibrate to produce sound. Singing bowls were traditionally used throughout Asia. Today they are employed worldwide both within and without these spiritual traditions, for meditation, trance-induction, relaxation, healthcare, personal well-being and religious practice. Singing bowls were historically made in Tibet, Nepal, India, Bhutan, China, Japan and Korea. Today they are made in Nepal, India, Japan and Korea. The best known types of bowls are from the Himalayan region and are often called “Tibetan singing bowls.”

In general, singing bowls may be played by the friction of rubbing a wooden, plastic, or leather wrapped mallet around the rim of the bowl to produce overtones and a continuous ‘singing’ sound. High quality singing bowls produce a complex chord of harmonic overtones. Singing bowls may also be played by striking with a soft mallet to produce a warm bell tone.

Singing bowls are unique because they are multiphonic instruments, producing multiple harmonic overtones at the same time. The overtones are a result of using an alloy consisting of multiple metals, each producing its own overtone. New bowls can also produce multiple harmonic overtones if they are high quality bronze, but many are made from a simpler alloy and produce only a principal tone and one harmonic overtone.

Singing bowls may be used as an aid to meditation and as a tool for trance induction. They are also used in yoga, music therapy, sound healing, religious services, performances, and for personal enjoyment.

### SUMMARY

The following embodiments and aspects of thereof are described and illustrated in conjunction with systems, tools, and methods which are meant to be exemplary and illustrative, and not limiting in scope. In various embodiments, one or more of the above-described problems have been reduced or eliminated, while other embodiments are directed to other improvements.

According to a first aspect, an apparatus for providing sound therapy to a person is provided. The apparatus includes a primary support structure operative to support a person in a substantially horizontal position, and a plurality of auxiliary support structures disposed proximate to the primary support structure. Each of the plurality of auxiliary support structures are operative to support one or more sound generating devices positioned near one or more chakras of a person lying on the primary support structure.

According to a second aspect, an apparatus for providing sound therapy to a person is provided. The apparatus includes a mat having dimensions such that a person may lie horizontally thereon. Further, the apparatus includes a plurality of speakers disposed on the mat in predetermined locations that correspond to chakras of a person lying on the mat. In addition, the apparatus includes an interface that is operative to couple the plurality of speakers to an electronic device.

According to a third aspect, a method for providing sound therapy to a person is provided. The method includes providing a primary support structure operative to support a person in a substantially horizontal position. The method further includes providing a plurality of auxiliary support structures disposed proximate to the primary support structure, such that each of the plurality of auxiliary support structures are operative to support one or more sound generating devices positioned near one or more chakras of a person lying on the primary support structure.

In addition to the exemplary aspects and embodiments described above, further aspects and embodiments will become apparent by reference to the drawings and by study of the following descriptions.

### BRIEF DESCRIPTION OF THE DRAWINGS

FIG. 1 illustrates various energy centers or chakras for a person's body.

FIGS. 2A-2I illustrate various views of an exemplary sound healing table.

FIG. 3 illustrates a top schematic view of the exemplary sound healing table shown in FIGS. 2A-2I.

FIG. 4 illustrates a top schematic view of another exemplary sound healing table.

FIG. 5 illustrates another exemplary sound healing table that includes a framework for supporting sound generating devices.

FIG. 6 illustrates another exemplary sound healing table that includes a framework for supporting sound generating devices.

FIG. 7 illustrates another exemplary sound healing table that includes adjustable support structures for sound generating devices.

FIG. 8 illustrates another exemplary sound healing table that includes standalone support structures for sound generating devices.

FIG. 9A-9C illustrate an exemplary mat that may be used for sound healing.

FIG. 10 illustrates an exemplary chair that may be used for sound healing.

FIG. 11 illustrates an exemplary portable sound healing table.

### DETAILED DESCRIPTION

While the invention is susceptible to various modifications and alternative forms, specific embodiments thereof have been shown by way of example in the drawings and are herein described in detail. It should be understood, however, that it is not intended to limit the invention to the particular form disclosed, but rather, the invention is to cover all modifications, equivalents, and alternatives falling within the scope and spirit of the invention as defined by the claims.

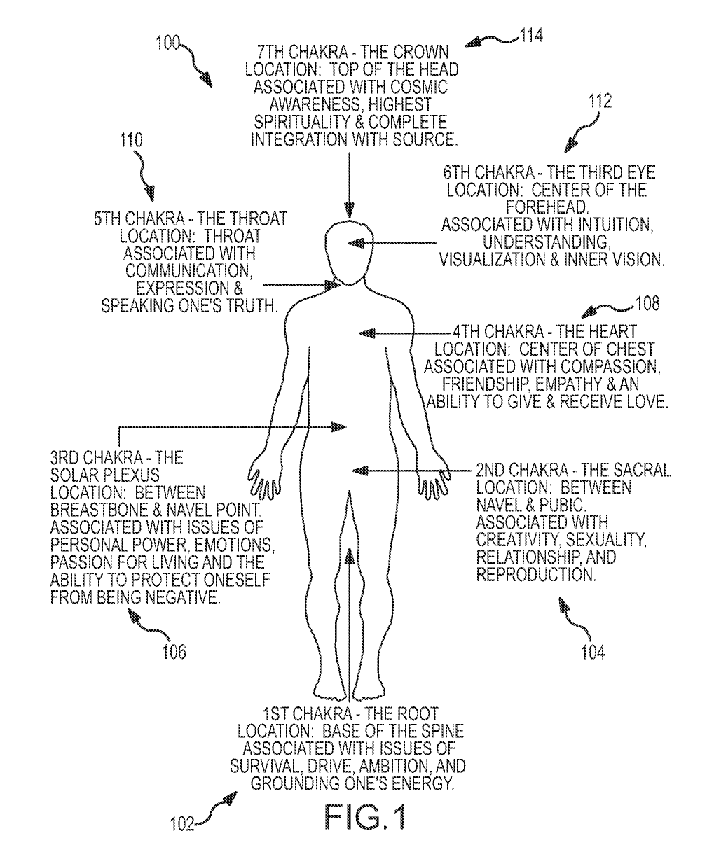

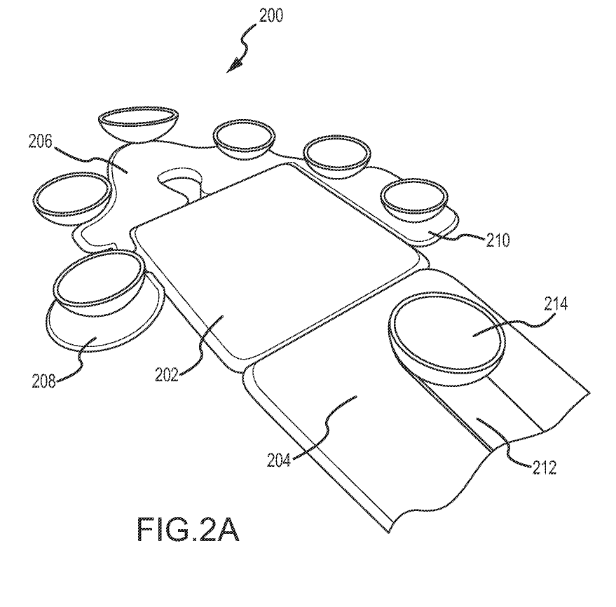

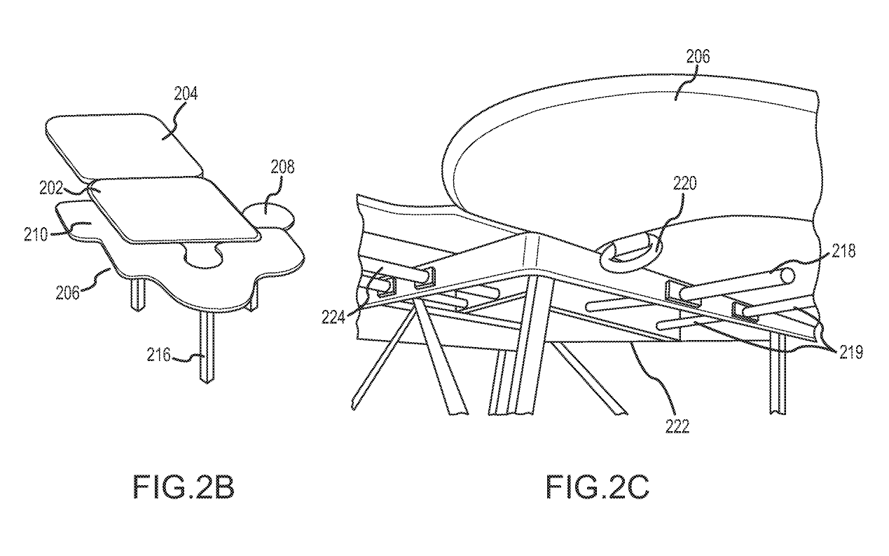

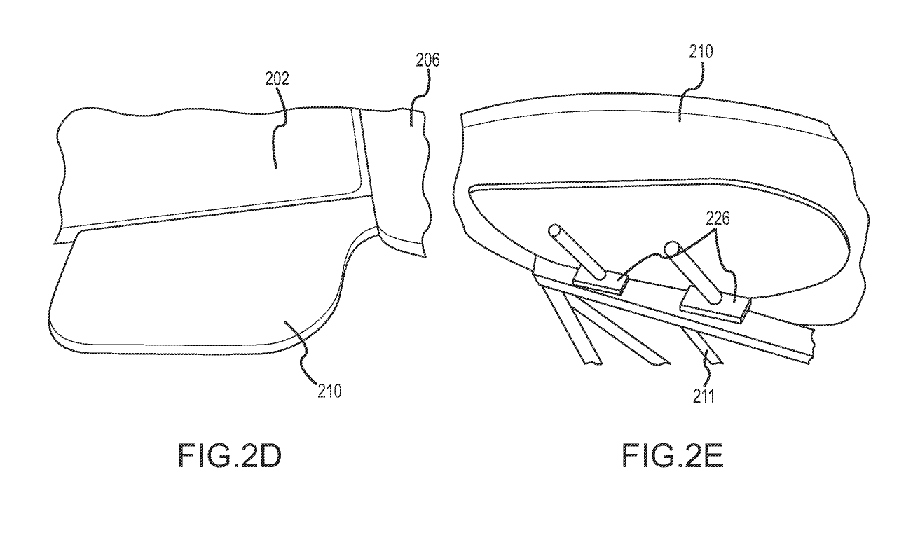

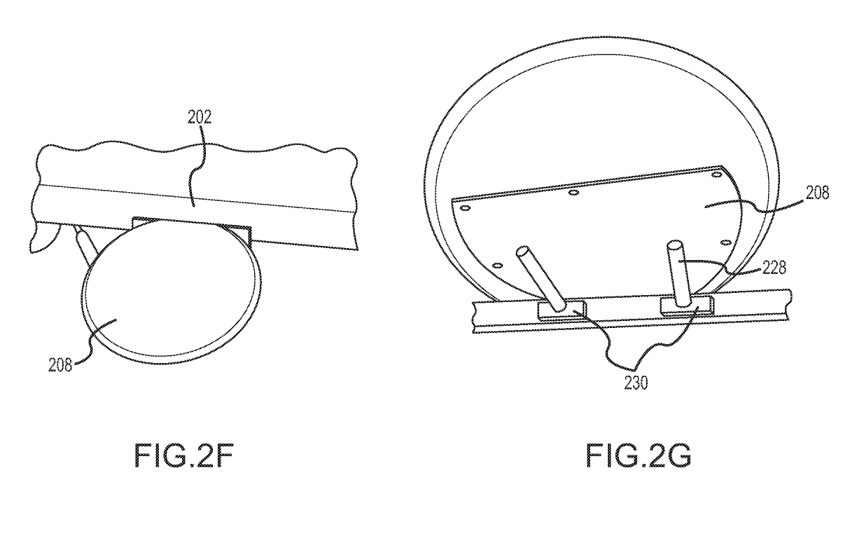

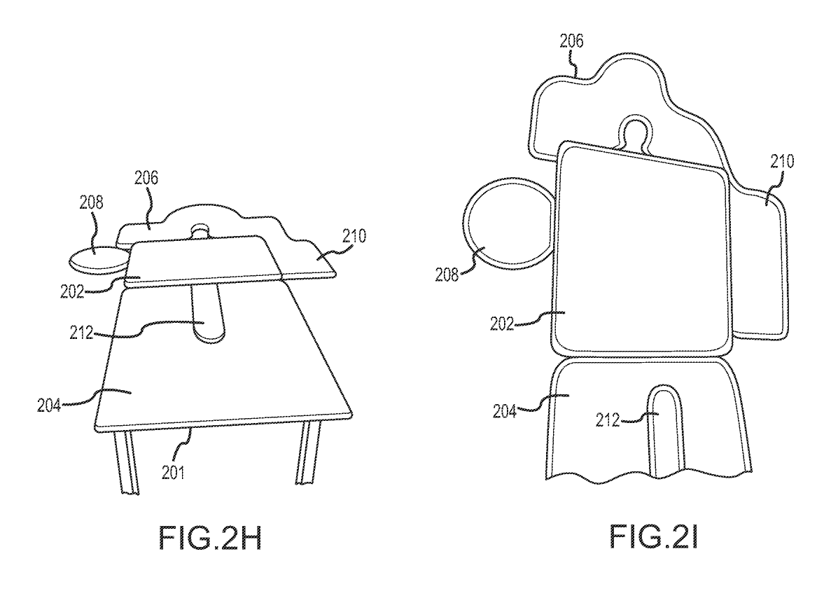

In the following discussion, various systems and methods for providing sound healing to a person are described. First, with reference to FIGS. 1, an overview is provided of the chakra system that may serve as the reference for positioning sound generating devices used in sound healing sessions. Next, with reference to FIGS. 2-11, particular embodiments of systems and methods for providing sound healing are discussed.

One aspect of the application of sound healing relates to treatment of the body's chakras. The word “chakra” is a Sanskrit word meaning wheel or disk. Described as a wheel-like spinning vortex, a chakra is a point of intersection between various planes. In general, the seven major centers along the spinal column have the greatest significance and the highest number of correlations in the treatment of chakras. These seven centers are thought of as the master chakras. Chakras are believed to be opened or closed, dying or budding, depending on the consciousness within. Chakras are associated with seven basic levels of consciousness. The seven master chakra centers are shown in FIG. 1 (with reference to a person's body 100) and are identified below.

The first chakra 102 (or root chakra) is related to instinct, security, survival, and also to basic human potentiality. This center is located in the region at the base of the spine. Although no endocrine organ is placed here, it is said to relate to the gonads and the adrenal medulla, responsible for the fight and flight response when survival is under threat.

The second chakra 104 (or sacral chakra) is located in the sacrum between the navel and the pubic region and is considered to correspond to the various sex hormones involved in the reproductive cycle. The second chakra 104 is also considered to be related to, more generally, the genitourinary system and the adrenals. The second chakra 104 governs reproduction, creativity, joy, and enthusiasm.

The third chakra 106 (or solar plexus chakra) is related to the metabolic and digestive systems and is located between the breastbone and the navel point. Key issues governed by the third chakra 106 are issues of personal power, fear, anxiety, opinion-formation, introversion, and digestion.

The fourth chakra 108 (or heart chakra) is located in the chest, and relates to complex emotions, compassion, tenderness, unconditional love, equilibrium, rejection well being, and circulation.

The fifth chakra 110 (or throat chakra) may be understood as relating to communication and growth through expression. This chakra 110 is paralleled to the thyroid, a gland that is also in the throat and which produces thyroid hormone, responsible for growth and maturation.

The sixth chakra 112 (or third eye chakra) is linked to the pineal gland which may inform a model of its envisioning. The pineal gland is a light sensitive gland that produces the hormone melatonin which regulates sleep and awakening. The key issues of the sixth chakra 112 involve balancing the higher & lower selves and trusting inner guidance, the access of intuition, and clarity on an intuitive level.

The seventh chakra 114 (or crown chakra) is located on top of the head and is generally considered to be the chakra of pure consciousness. The seventh chakra 114 involves such issues as cosmic awareness, inner wisdom, and mental action with universal consciousness and unity.

In a typical sound healing session, a plurality of sound generating devices (e.g., singing bowls) may be positioned near each of the seven chakras. Further, each of the sound generating devices may be designed or tuned to specific frequencies (or notes) that affect each individual chakra.

FIGS. 2A-2I illustrate various views of an exemplary sound healing table 200. The table 200 includes a primary support structure (or platform) that includes an upper portion 202 and a lower portion 204. The upper and lower portions 202, 204 may generally be constructed from a padded material which may provide comfort for person lying horizontally on the table 200. As shown in FIG. 2A, the table 200 includes a plurality of auxiliary support structures (or sound generating devices support structures) 206, 208, and 210. The auxiliary support structures 206, 208, and 210 may be used to support a plurality of singing bowls 214. The structures 206, 208, and 210 may be permanently or temporarily attached to the primary support structure by any suitable means. In this embodiment, the auxiliary support structures 206, 208, 210 are configured in locations proximate to the main support structure to permit the singing bowls 214 to be positioned near the seven chakra centers of a person lying on the sound healing table 200.

Further, a fin 212 may be positioned in or on the lower portion 204 of the primary support structure and operative to support a singing bowl near the root chakra of a person lying on the table 200. As can be appreciated, the padding on the lower portion 204 of the support structure may dampen vibration of the singing bowl 214 in an undesirable manner. In this regard, the fin 212 may be constructed from a substantially more rigid material (e.g., wood, plastic, metal, or the like), such that the dampening of the singing bowl 214 placed on the fin 212 may be reduced, thereby permitting the singing bowl 214 near the root chakra to generate a desired tone.

It should be appreciated that one benefit of the table 200 is that it enables a person to participate in sound healing sessions without the need to lie on the floor. This may be advantageous in several circumstances. For example, certain people may have physical limitations that prohibit them from lying on the floor (e.g., weight, age, or other physical limitations). In this regard, the sound healing table 200 may provide such people with the ability to receive sound healing when they would not be able to otherwise.

FIG. 2C illustrates the selective coupling between the auxiliary support structure 206 and the upper portion 202 of the primary support structure. The auxiliary support structure 206 includes two dowel rods 218 that are insertable into apertures 219 located on the side of the table 200. To secure the auxiliary support structure 206 to the upper portion 202 of the primary support structure, a fastening means may be used. In this embodiment, a velcro strap 220 is used. However, it should be appreciated that other fastening means may be used (e.g., snaps, buckles, or the like). To further ensure the stability of the auxiliary support platforms 206, 208, and 210, boards (e.g., a board 222 shown in FIG. 2C) may be provided on the bottom side of the upper portion 202 of the primary support structure to prevent the dowel rods (e.g., the dowel rod 218 shown in FIG. 2C) from moving during a sound healing session.

FIG. 2B illustrates a support leg 216 that may be provided for the auxiliary support structure 206 to provide additional support and stability for the structure 206 when the singing bowls 214 are placed thereon. In this embodiment, the additional support provided by the leg 216 may be desirable because a person's head may rest on the auxiliary support structure 206, and it may be undesirable to have significant movement of the structure 206 during the sound healing session (e.g., caused by striking the singing bowls during the sound healing session).

FIGS. 2D and 2E illustrate views of the coupling between the auxiliary support structure 210 and the upper portion 202 of the main support structure. As shown in FIG. 2E, the dowel rods 211 of the auxiliary support structure 210 are inserted into apertures 226 on the side of the upper portion 202 of the main support structure.

FIGS. 2F and 2G illustrate views of the coupling between the auxiliary support structure 208 and the upper portion 202 of the main support structure. As shown in FIG. 2G, the dowel rods 228 of the auxiliary support structure 208 are inserted into apertures 230 on the side of the upper portion 202 of the main support structure. Although not shown in FIGS. 2D-2G, suitable fastening means may be provided to secure the auxiliary support structures 208, 210 to the upper portion 202 of the main support structure.

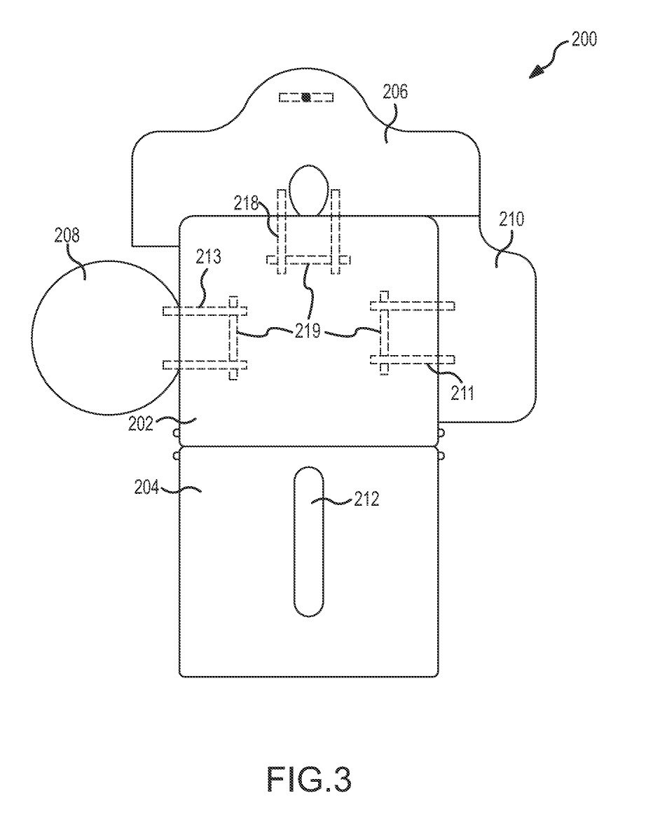

FIG. 3 illustrates a top schematic view of the sound healing table 200 shown in FIGS. 2A-2I. As can be seen, the auxiliary support structures 206, 208, and 210 are coupled to the upper portion 202 of the main support structure via the dowel rods 218, 213, and 211, respectively. In addition, boards 219 are disposed on the underneath side of the upper portion 202 to prevent the auxiliary support structures from moving during a sound healing session.

It should be appreciated that the specific embodiments shown in FIGS. 2A-2I and FIG. 3 are exemplary rather than limiting. For example, the number and size of the auxiliary support structures may vary (e.g., several support structures, one support structure, or the like) to suit a particular application.

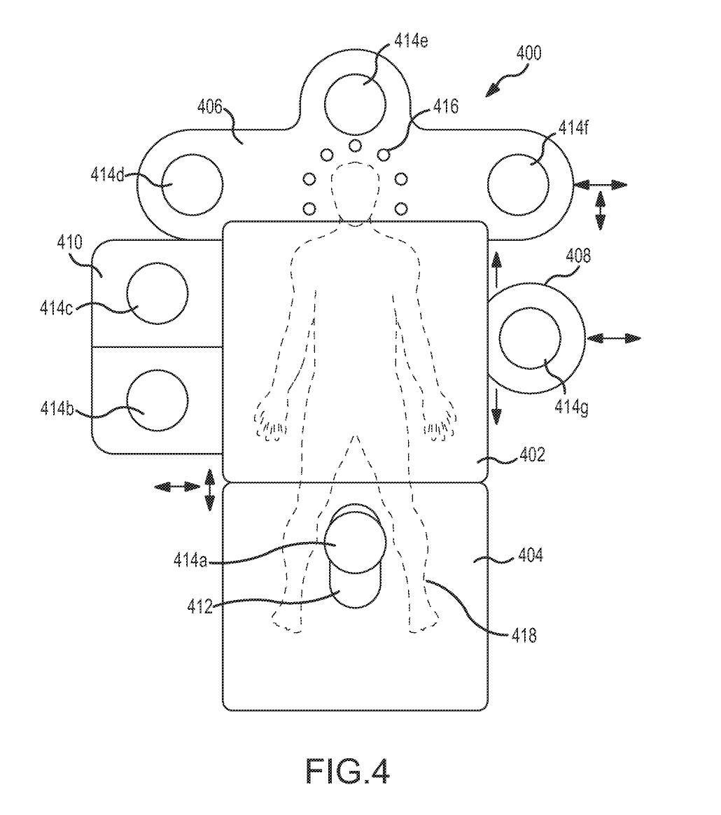

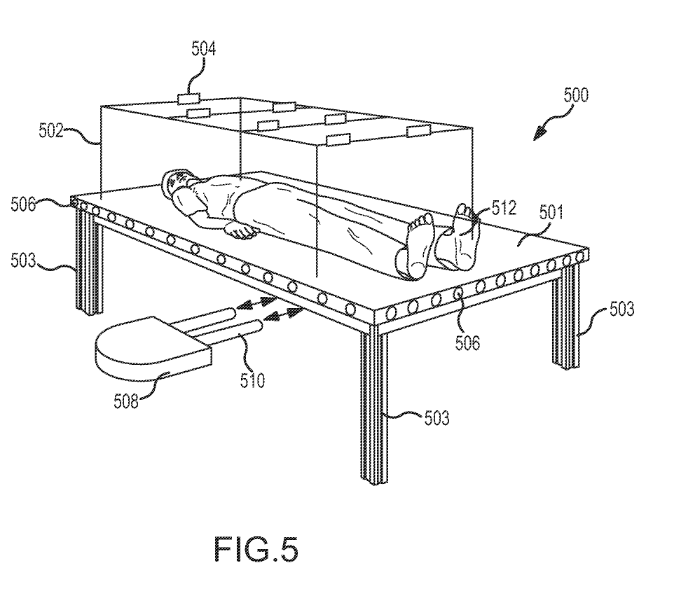

FIG. 4 illustrates another embodiment of a sound healing table 400 that may be used for sound healing. The table 400 includes an upper portion 402 and a lower portion 404 of a primary support structure that is operative to support a person lying horizontally on the table 400. The table 400 also includes auxiliary support structures 406, 408, and 410, which may be utilized to support a plurality of sound generating devices 414a-g (e.g., singing bowls, speakers, or the like). Additionally, a plurality of sound generating devices 416 may be positioned on the auxiliary support structure 406 surrounding the head of a person 418 lying horizontally on the table 400. The sound generating devices 416 may correspond to chakras associated with the mind of a person 418 lying on the table 400. Similar to the table 200 shown in FIGS. 2A-2I and FIG. 3, the sound healing table 400 may include a fin 412 for supporting the sound generating device 414a positioned near the root chakra of the person 418.

As shown by the arrows near the auxiliary support structures 406, 408, and 410, the auxiliary support structures may be adjustable in one or more horizontal and/or vertical directions. As an example, the auxiliary support structures 406, 408, and 410 may be coupled to the primary support structure via rails, such that they are slidable in one or more directions. This may be advantageous to accommodate the positioning of the sound generating devices 414a-g in different locations. For example, it may be desirable to position the sound generating devices 414a-g in different locations relative to the person 418 for sound healing sessions having differing objectives. In addition, the positioning of the sound generating devices 414a-g may be adjusted to suit a person 418 of different body types (e.g., people of different height, or the like).

FIG. 5 illustrates another exemplary sound healing table 500 that may be used for sound healing. The table 500 includes a primary support surface 501 and four legs 503. As can be appreciated, the legs 503 may be adjustable such that the height of the primary support surface 501 may be adjusted to a desired position. The primary support surface 501 may be sized generally such that a person 512 may lie horizontally thereon. The table 500 may further include a framework 502 that is operative to support a plurality of sound generating devices 504 (e.g., singing bowls, speakers, or the like) at a position above the person 512 lying on the primary support surface 501. In this regard, the sound generating devices 504 may be positioned above the person 512 proximate to one or more chakra centers. In addition, the height of the framework 502 may be selectively adjustable to allow a sound healing instructor to customize the framework 502 for a particular person or practice. Further, the framework 502 may permit the plurality of sound generating devices 504 to be configured in any number of ways. For example, in one embodiment, the framework 502 may support sound generating devices 504 in positions near the seven chakras of the person 512 lying on the sound healing table 500.

The sound healing table 500 may also include a plurality of apertures (or slots) 506 located along one or more sides of the primary support surface 501. In this regard, an auxiliary support structure 508 that includes rods 510 (e.g., dowel rods) may be selectively coupled to the table 500 by inserting the rods 510 into the apertures 506. Thus, one or more sound generating devices may be placed on the auxiliary support structure 508 near the person 512. As can be appreciated, the position of the auxiliary support structure 508 relative to the primary support surface 501 may be adjusted by selectively inserting the rods 510 into different pairs of apertures 506 along a side of the primary support surface 501.

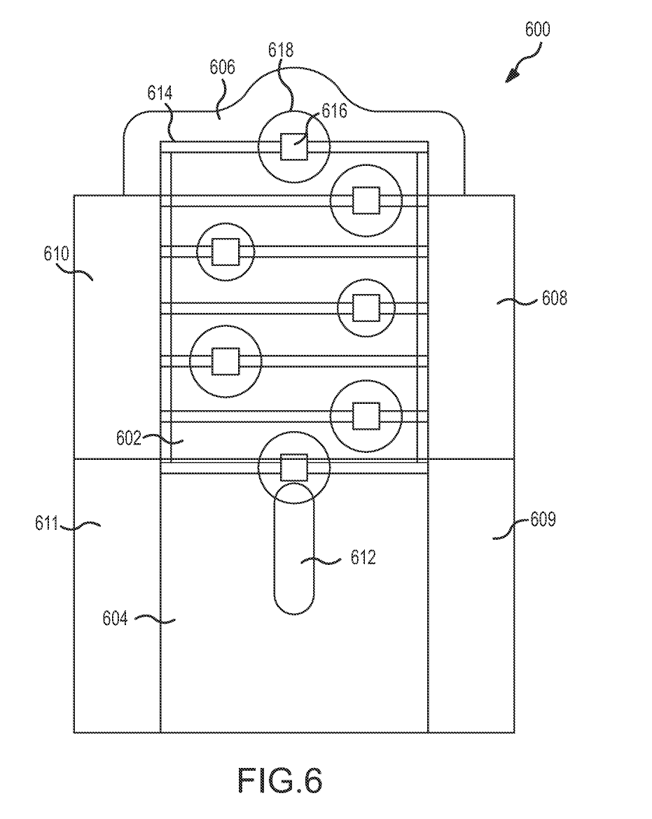

FIG. 6 illustrates a top schematic view of a sound healing table 600 that may be used for sound healing. The table 600 includes an upper portion 602 and a lower portion 604 of a primary support surface sized to support a person lying in a horizontal position thereon. The sound healing table 600 also includes a plurality of auxiliary support structures or surfaces 606, 608, 609, 610, and 611 that are operative to support one or more sound generating devices (e.g., singing bowls, speakers, or the like). The auxiliary support surfaces 606, 608, 609, 610, and 611 may be permanently or selectively attached to the upper portion 602 and the lower portion 604 of the primary support surface. Further, the table 600 includes a fin 612 which may be formed from a relatively rigid material (e.g., wood, plastic, or the like) such that a sound generating device placed thereon may vibrate without significant dampening.

The table 600 further includes a framework 614 that may be positioned above the upper portion 602 (or lower portion 604) of the primary support structure. The framework 614 may include a plurality of support structures 616 operative to support sound generating devices 618. For example, the support structure 616 may include a platform that supports a singing bowl. The position of the plurality of support structures 616 may also be adjustable. For example the support structures 616 may be adjusted by a sound healing instructor to various positions that correspond to the seven primary chakra centers of a person undergoing a sound healing session. As can be appreciated, the framework 614 may be selectively removable from the table 600, which may improve the portability and/or ease of storage for the sound healing table 600.

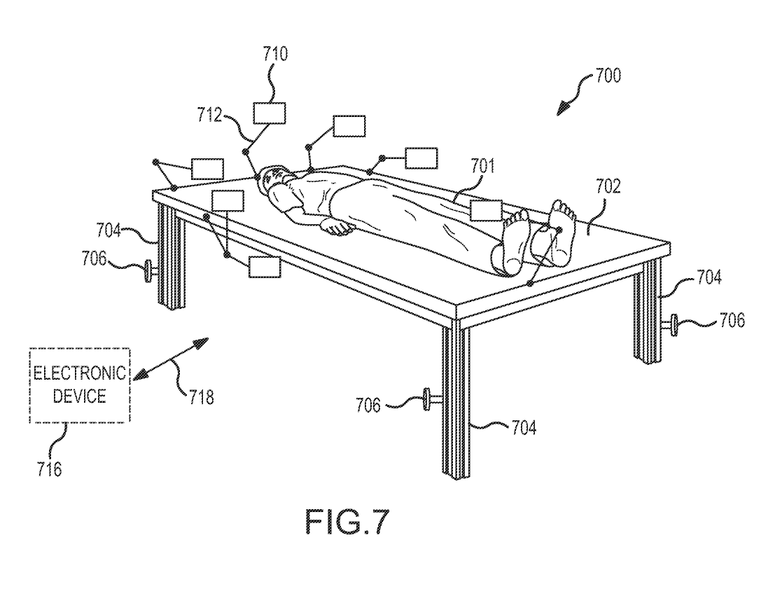

FIG. 7 illustrates another exemplary sound healing table 700 that may be used for sound healing. In this embodiment, the table 700 includes a primary support surface 702 sized to support a person 701 lying horizontally thereon. The table 700 also includes four legs 704. The height of the legs 704 may be adjusted using the adjustment means 706 (e.g., a knob) such that the height of the primary support service 702 may be suitably adjusted.

The sound healing table 700 also includes a plurality of adjustable arms 712 that are each coupled to sound generating devices 710 (e.g., speakers, singing bowls, or the like). In one embodiment, the adjustable arms 712 may include a plurality of sections and joints that allow the arms 712 to be moved by a sound healing instructor to a suitable position relative to the person 701 (e.g., similar to an architect lamp). The adjustable arms 712 may be fixedly or removably attached to the table 700. As can be appreciated, the arms 712 may be positioned at various points on the table 700 as desired.

Further, the sound generating devices 710 may be permanently or removably coupled to the adjustable arms 712. For example, in the case where the sound generating devices 710 include singing bowls, the adjustable arms 712 may include a platform that is sized to support one or more singing bowls. In addition, in the case where the sound generating devices 710 are speakers, each adjustable arm 712 may include one or more speakers fixedly attached thereto.

In the case where the sound generating devices 710 are speakers, an electronic device 716 may also be provided to drive the speakers to generate tones for a sound healing session. For example, the electronic device 716 may include a stereo, a portable music player, or a custom player integrated into the design of the table 700. The electronic device 716 may be coupled to the sound generating devices 710 via the coupling 718, which may be any suitable wired or wireless connection. Further, the electronic device 716 may be operative to cause the sound generating devices 716 to generate various tones in various sequences to provide a sound healing session for the person 701 lying on the sound healing table 700. The electronic device 716 may also include a user interface that allows the person 701 or a sound healing instructor to control the sounds generated by the sound generating devices 710. For example, the electronic device 716 may include a set of “programs” that may be selected to provide various sound healing sessions. Additionally or alternatively, the electronic device 716 may allow a user or instructor to generate individual tones by interacting with the interface of the electronic device 716 (e.g., by pressing buttons associated with individual tones).

As noted above, the electronic device 716 may be integrated as part of the table 700, or maybe a separate device. As an example, the electronic device 716 may be a portable music player, and the table 700 may include an interface for communicating with music player. In this regard, a program may be run on the music player to cause the sound generating devices 710 to generate sounds in accordance with a desired sound healing session. In this example, a user or instructor may control the music player to implement a sound healing session.

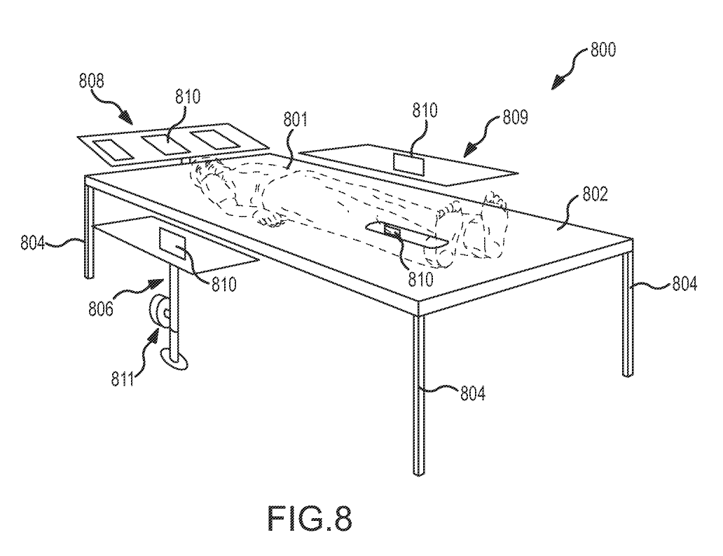

FIG. 8 illustrates another embodiment of an exemplary sound healing table 800 that may be used for sound healing. The table 800 includes a primary support surface 802 sized to support a person 801 lying horizontally thereon. The table 800 also includes four legs 804, which may be adjustable in height. Further, the table 800 includes a plurality of standalone platforms 806, 808, and 809 positioned around the primary support surface 802. The platforms 806, 808, and 809 may include height adjustment means (e.g., the knob 811) for adjusting the height of the platforms relative to the primary support surface 802. The platforms 806, 808, and 809 may be operative to support one or more sound generating devices 810 (e.g., singing bowls, speakers, or the like). As can be appreciated, the platforms may be moved relative to the primary support surface 802 such that the sound generating devices 810 may be positioned in desired locations relative to the person 801 participating in the sound healing session.

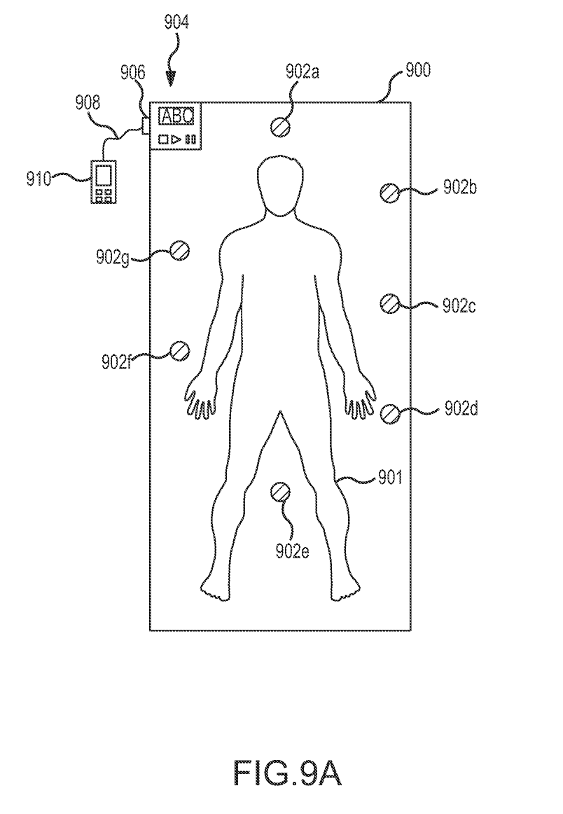

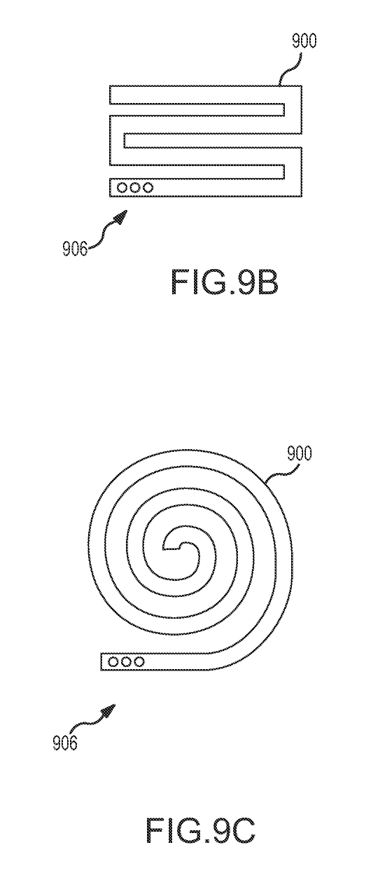

FIGS. 9A-9C illustrate a sound healing mat 900 that may be used to provide sound healing. The mat 900 may generally be sized such that a person 901 may lie horizontally thereon. The mat 900 may include a plurality of sound generating devices 902a-g (e.g., speakers) disposed on or embedded in the mat 900. The sound generating devices 902a-g may be positioned to coincide with various points on the body of the person 901. For example, the sound generating devices 902a-g may be positioned such that they coincide with the seven chakra centers of the person 901.

The mat 900 may include an input interface 906 that is operative to couple the sound generating devices 902a-g to an electronic device 910 via a wired or wireless communication link 908. Electronic device 910 may include a general or customized music player that is operative to cause the sound generating devices 902a-g to generate a desired sequence of sounds to perform a sound healing session for the person 901. As can be appreciated, the electronic device 910 may be external to the mat 900 or maybe integrated into the mat 900 itself. Further, the mat 900 may include a user interface 904 which may include a display and one or more controls operative to permit a user or instructor to select one or more features of a sound healing session. For example, a user may operate the interface 904 to select a particular sound healing session from a list of available sound healing sessions available on the electronic device 910.

FIGS. 9B-9C illustrate the sound healing mat 900 in two different folded positions. In FIG. 9B, the mat 900 is shown folded into quarter sections such that it may be easily carried and/or stored by a user. In FIG. 9C, the mat 900 is shown “rolled up,” which may also provide for easier transport and/or storage of the mat 900. As can be appreciated, other configurations for the mat 900 may be provided to enable easier storage, transportability, or other desirable features.

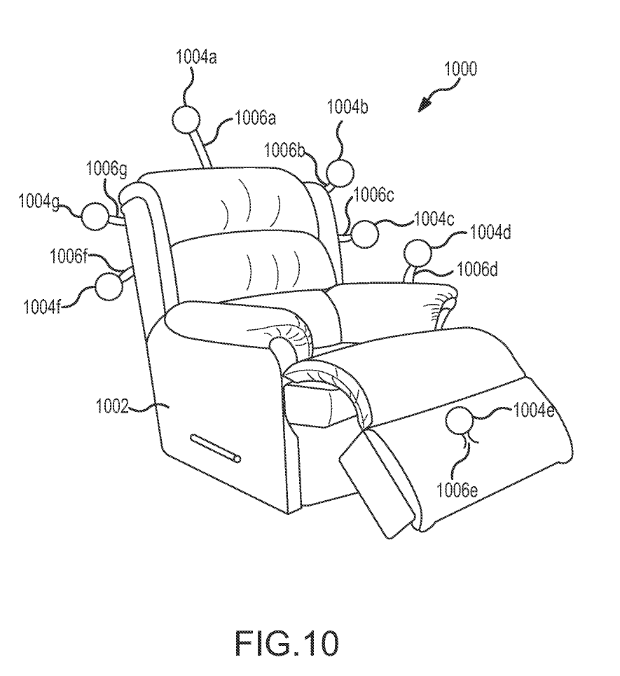

FIG. 10 illustrates an exemplary sound healing apparatus 1000 that may be used for sound healing. The apparatus 1000 may include a chair 1002 that includes a plurality of sound generating device support structures 1006a-g and a plurality of sound generating devices 1004a-g (e.g., singing bowls, speakers, or the like). The support structures 1006 may be adjustable relative to the chair 1002 such that the sound generating devices 1004 may be positioned near the seven chakra centers of a person sitting in the chair 1002. As can be appreciated, the support structures 1006 may be configured to support singing bowls and/or speakers. In the case where the sound generating devices 1004 are speakers, an electronic device (e.g., the electronic device 716 shown in FIG. 7) may also be provided to drive the speakers to implement a sound healing program.

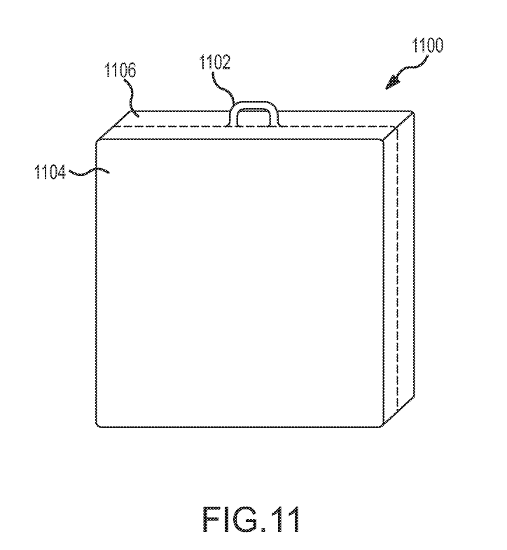

FIG. 11 illustrates a sound healing table 1100 that may be used for sound healing. The table 1100 may be similar to the other sound healing tables described herein. In this embodiment, the table 1100 includes an upper portion 1106 and a lower portion 1104 of a primary support surface that may be folded together such that the table 1100 may be relatively portable. In this regard, the table 1100 may include a handle 1102 to permit a person to easily carry the table 1100 from one location to another (e.g., similar to a massage table). As can be appreciated, other features may be utilized that allow the various sound healing tables described herein to be portable. As one example, the tables may be constructed from a relatively lightweight material so that an individual person may transport the tables. As another example, the tables may include one or more compartments for storing various components (e.g., auxiliary support structures, fasteners, sound generating devices, and the like) associated with the table.

As can be appreciated, various types of sound healing therapy may be performed using the embodiments of the present invention. Below is a description of two such therapies, namely a Relaxation Therapy and a Chakra Balancing Therapy. Each of these or other types of therapies may be performed using the embodiments described herein. For example, the various sequences may be performed using singing bowls or by using speakers driven by an electronic device. For illustrative purposes, the two therapies described below are discussed with reference to using singing bowls.

Relaxation Therapy includes three parts, and may generally be used to balance blood circulation and to produce a relaxation response in a person. Seven singing bowls (or speakers) are for this healing protocol, each positioned next to its corresponding healing Chakra position. In a Traditional layout, a B bowl (e.g., a bowl or sound generating device configured to generate a “B” note) is at the Crown Chakra, an E bowl is at the 3rd Eye Chakra, an A bowl is at the Throat Chakra, a D bowl is at the Heart Chakra, a G bowl is at the Solar Plexus Chakra, a C bowl is at the Sacral Chakra, and an F bowl is between the legs around the knee area for the Root Chakra. In this method, the bowls do not touch the body. Before beginning, one should verify that the position of each bowl is 2-4 inches away from the person's body and that the bowls are not touching anything that would dampen the bowls' healing vibrations.

Each of the three parts of this Relaxation Therapy has distinct multi-note bowl sequence patterns. When striking a multi-note bowl sequence, one should pause about 5 seconds between each bowl that is struck in the sequence. After the final bowl in a multi-note sequence is played, one should pause about 20 seconds before proceeding to the next sequence.

Part 1 begins by striking a first four bowl BFDG multi-note sequence with a soft mallet. This will be repeated 3 times, followed by a second unique multi-note sequence played one time only. This pattern of 3 identical sequences followed by a single unique sequence will be performed 3 times in Part 1 of this therapy.

An example sequence may be as follows: Strike B, pause 5 seconds; Strike F, pause 5 seconds; Strike D, pause 5 seconds; Strike G; pause for 20 seconds, or until the sound almost completely dissipates; repeat this multi-note sequence 2 more times.

After completing the first multi-note sequence, the first of 3 unique sequences, played only one time through: Strike B, pause 5 seconds; Strike F, pause 5 seconds; Strike D, pause 5 seconds; Strike G, pause 5 seconds; Strike C; pause for 20 seconds, or until the sound almost completely dissipates.

Next, perform a second repetition of the BFDG bowl sequence 3 times through. Remember, this will be followed by a second unique bowl sequence The second unique sequence may then be played only one time through: Strike B, pause 5 seconds; Strike F, pause 5 seconds; Strike D, pause 5 seconds; Strike G, pause 5 seconds; Strike C, pause 5 seconds; Strike A; pause for 20 seconds, or until the sound almost completely dissipates.

Next, perform a third and final repetition of the BFDG bowl sequence 3 times through. Remember, this will be followed by a final unique bowl sequence. The final of 3 unique sequences may then be played only one time through: Strike C, pause 5 seconds; Strike A, pause 5 seconds; Strike E; pause for 20 seconds, or until the sound almost completely dissipates.

Part 2 of the Relaxation Therapy includes a single multi-note sequence played one time only. The sequence may include: Strike B, pause 5 seconds; Strike E, pause 5 seconds; Strike A, pause 5 seconds; Strike D, pause 5 seconds; Strike G, pause 5 seconds; Strike C, pause 5 seconds; Strike F; pause for 20 seconds, or until the sound almost completely dissipates.

Part 3 concludes the Relaxation Therapy. It includes four unique multi-note sequences, each played one time only. The sequence for Part 3 may include: Strike F, pause 5 seconds; Strike C, pause 5 seconds; Strike G, pause 5 seconds; Strike D, pause 5 seconds; Strike A, pause 5 seconds; Strike E, pause 5 seconds; Strike B; pause for 20 seconds, or until the sound almost completely dissipates; Strike F, pause 5 seconds; Strike B; pause for 20 seconds; Strike D, pause 5 seconds; Strike G; pause for 20+ seconds; Strike C, pause for 5 seconds; Strike A, pause 5 seconds; Strike E; pause for 20+ seconds or until the healing vibrations fully dissipate. Finally, strike small chakra bowls which are positioned around the person's head for tranquility. This concludes the Relaxation Therapy method.

The next type of therapy described herein may be referred to as Chakra Balancing Therapy. This healing protocol takes approximately 12 minutes, and includes 3 parts. Each of the 3 parts is repeated 3 times.

For the Chakra Balance Therapy, a tingsha and 4 bowls, B, F, D, and G, may be used. Each bowl will be positioned next to its corresponding healing Chakra position. In the Traditional bowl layout check that: the B bowl is at the Crown Chakra; the F bowl is between the legs around the knee area for the Root Chakra; the D bowl is at the Heart Chakra; and the G bowl is at the Solar Plexus Chakra.

In this method, the bowls do not touch the body. Before beginning, check that each bowl is about 2-4” away from the client's body and that the bowls are not touching anything that would dampen the bowls' healing vibrations. The bowls will be played with a soft mallet in a consistent sequence throughout, and as the vibrations of the bowl sequence dissipates, the tingsha should be played as instructed below.

Part 1: Share heart to heart Chakra healing energy. The purpose of Part 1 is to create a healing energy connection between the Client and the Healer. For Part 1, play the bowl sequence as follows: Strike B, pause 5 seconds; Strike F, pause 10 seconds; Strike DG three (3) times without pausing; quickly play the tingsha; and move them from your Healer's Heart Chakra to a few inches above the client's Heart Chakra; move the tingsha upward to the client's Throat Chakra, to 3rd Eye Chakra; and then down to the Sacral Chakra; retrace it back up to Throat Chakra, to 3rd Eye Chakra; from there bring it back to your Heart Chakra to complete the healing energy circuit; repeat this sequence 2 more times.

Part 2: Opening the 3rd Eye Chakra. The purpose of Part 2 is to open your intuition.

Initially, play the bowl sequence the same as in Part 1: Strike B, pause 5 seconds; Strike F, pause 10 seconds; Strike DG three (3) times without pausing between; quickly play the tingsha; next, start 1.5 feet above client's 3rd Eye Chakra; then move quickly down to 1″ above their 3rd Eye Chakra; then move the tingsha down to their Throat Chakra, Heart Chakra and finally to their Sacral Chakra; with the tingsha still vibrating, retrace back up to the Throat Chakra, Heart Chakra, and finally 3rd Eye Chakra; then slowly raise the tingsha back to 1.5′ above client's 3rd Eye Chakra; repeat this sequence 2 more times.

Part 3: Balancing the Chakras. The purpose of Part 3 is to create balance and harmony between the Chakra centers. Initially, play the bowl sequence the same as in Part 1 & 2: Strike B, pause 5 seconds; Strike F, pause 10 seconds; Strike DG three (3) times without pausing between; quickly play the tingsha; next, start 1.5 feet above client's Sacral Chakra; then move the tingsha down to 1″ above the receiver's Sacral Chakra. With the tingsha vibrating, move the tingsha up to the client's Throat Chakra, Heart Chakra , to 3rd Eye Chakra; then retrace with the tingsha back up to the Throat Chakra, Heart Chakra, and finally to their Sacral Chakra. Slowly raise the tingsha back to 1.5′ above client's Sacral Chakra; finally, repeat this sequence 2 more times. This completes the Chakra Balancing Therapy.

The sound healing systems and methods described herein may provide several advantages. For example, some of the embodiments permit people to receive sound healing therapy without having to lie on the floor, which may be difficult for some people with physical ailments. Further, the various embodiments utilizing speakers and electronic devices may allow a variety of sound healing sessions to be performed in a variety of settings. Further, the sound healing mat described above may allow people to experience sound healing therapy in a convenient and economical manner. Those skilled in the art will readily recognize these and other advantages provided by the embodiments described herein.

While the invention has been illustrated and described in detail in the drawings and foregoing description, such illustration and description is to be considered as exemplary and not restrictive in character. For example, certain embodiments described hereinabove may be combinable with other described embodiments and/or arranged in other ways (e.g., process elements may be performed in other sequences). Accordingly, it should be understood that only the preferred embodiment and variants thereof have been shown and described and that all changes and modifications that come within the spirit of the invention are desired to be protected.

1. An apparatus for providing sound therapy to a person, the apparatus comprising:
a primary support structure operative to support a person in a substantially horizontal position; and
a plurality of auxiliary support structures disposed proximate to the primary support structure, such that each of the plurality of auxiliary support structures are operative to support one or more sound generating devices positioned near one or more chakras of a person lying on the primary support structure.

2. The apparatus of claim 1, wherein the plurality of auxiliary support structures includes exactly three auxiliary support structures operative to support a total of six sound generating devices.

3. The apparatus of claim 2, wherein the primary support structure includes an aperture located at a position that is proximate to a chakra of a person lying on the primary support structure, the apparatus further comprising:
a fin positioned within the aperture of the primary support structure, the fin being operative to support a sound generating device.

4. The apparatus of claim 1, wherein the plurality of auxiliary support structures are selectively attachable to the primary support structure.

5. The apparatus of claim 1, wherein the primary support structure includes a plurality of apertures positioned along one or more sides, and wherein each of the plurality of auxiliary support structures comprise one or more rods that are insertable into the apertures such that the plurality of auxiliary support structures may be engaged with the primary support structure.

6. The apparatus of claim 5, further comprising:
fastening means operative to selectively attach each of the plurality of auxiliary support structures to the primary support structure.

7. The apparatus of claim 1, wherein the primary support structure is foldable.

8. The apparatus of claim 1, wherein the primary support structure comprises:
a cushioned portion operative to provide comfort to a person lying on the primary support structure; and
a substantially firm portion operative to support a sound generating device.

9. The apparatus of claim 1, wherein the plurality of auxiliary support structures are movable in at least one of a horizontal and vertical direction relative to the primary support structure.

10. The apparatus of claim 1, further comprising:
a framework positionable above the main support structure and being operative to support a plurality of sound generating devices.

11. The apparatus of claim 1, wherein the auxiliary support structures include markings to indicate to a user a desired position to place a sound generating device.

12. The apparatus of claim 1, further comprising:
a plurality of sound generating devices positioned adjacent to the plurality of auxiliary support structures, wherein each of the sound generating device are positioned such that they are near one charka of a person lying on the main support structure.

13. The apparatus of claim 12, wherein each of the plurality of sound generating devices comprises one of a speaker and a singing bowl.

14. The apparatus of claim 12, wherein each of the plurality of sound generating devices comprises speakers, the apparatus further comprising:
an interface operative to couple the plurality of speakers to an electronic device.

15. The apparatus of claim 14, further comprising:
an electronic device coupled to the plurality of speakers through the interface, wherein the electronic device is operative to cause the plurality of speakers to generate a sequence of sounds.

16. An apparatus for providing sound therapy to a person, the apparatus comprising:
a mat having dimensions such that a person may lie horizontally thereon;
a plurality of speakers disposed on the mat in predetermined locations that correspond to chakras of a person lying on the mat; and
an interface that is operative to couple the plurality of speakers to an electronic device.

17. The apparatus of claim 16, wherein the interface is operative to couple the plurality of speakers to an external music player.

18. The apparatus of claim 16, further comprising:
an electronic player coupled to the plurality of speakers through the interface, the electronic player being operative to cause the plurality of speakers to generate a sequence of sounds; and
a user interface coupled to the electronic player that allows a user to control the operation of the electronic player.

19. The apparatus of claim 16, wherein the mat is foldable.

20. A method for providing sound therapy to a person, the method comprising the steps of:
providing a primary support structure operative to support a person in a substantially horizontal position; and
providing a plurality of auxiliary support structures disposed proximate to the primary support structure, such that each of the plurality of auxiliary support structures are operative to support one or more sound generating devices positioned near one or more chakras of a person lying on the primary support structure.
